(19) United States
(12) Patent Application Publication
(10) Pub. No.: US 2007/0126805 A1
(43) Pub. Date: Jun. 7, 2007

(54) Liquid drop discharge head and method of manufacturing the same

(75) Inventors: Kazufumi Oya, Suwa (JP); Yasushi Matsuno, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/607,110

(22) Filed: Nov. 30, 2006

(30) Foreign Application Priority Data
Dec. 1, 2005 (JP) 2005-347832

(51) Int. Cl. B41J 2/045

(52) U.S. Cl. 347/71

(57) ABSTRACT

A liquid drop discharge head of four-layer structure according to an aspect of the invention including: a nozzle substrate having a plurality of nozzle holes; a cavity substrate having a plurality of independent discharge chambers that communicate with the respective nozzle holes and generate a pressure in the chambers for discharging liquid drops through the nozzle holes; and a reservoir substrate forming a reservoir space that communicates commonly with the discharge chambers, wherein the reservoir substrate has a diaphragm portion provided by reducing the thickness of a part of a wall surface forming the reservoir space.

The entire disclosure of Japanese Patent Application No. 2005-347832, filed Dec. 1, 2005, is expressly incorporated by reference herein.

### BACKGROUND

1. Field of the Invention

The present invention relates to a liquid drop discharge head such as an inkjet head or the like and a method of manufacturing the same.

2. Description of the Related Art

As a liquid drop discharge head for discharging liquid drops, for example, an inkjet head mounted to an inkjet recording device is known. The inkjet head generally includes a nozzle substrate having a plurality of nozzle holes for discharging ink drops formed thereon, and a cavity substrate being joined to the nozzle substrate and forming an ink channel such as a discharge chamber, a reservoir or the like which communicates with the nozzle holes in cooperation with the nozzle substrate, so that ink drops are discharged from the selected nozzle holes by applying a pressure to the discharge chamber by a drive unit. The drive unit may be of a system using electrostatic force, a piezoelectric system using a piezoelectric element, a system using a heat-generating element, and so on.

The inkjet head configured as described above is required to have a structure including a plurality of nozzle rows for the purposes of achieving high-speed printing and of color printing. In addition, in recent. years, the nozzle is increased in density, and is elongated (increased in number of nozzles in one row), so that the number of actuators in the inkjet head is more and more increased.

Since a reservoir which is common to the respective nozzle holes is provided in the inkjet head, the pressure in the discharge chamber is transmitted to the reservoir in association with increase in nozzle density, and hence the pressure also affects other nozzles. For example, when a positive pressure is applied to the reservoir by driving the actuator, ink drops may leak from non-driven nozzles other than the nozzle hole which is supposed to discharge the ink drops (driven nozzles), or when a negative pressure is applied to the reservoir, the ink drop discharge amount to be discharged from the driven nozzle may be reduced, thereby deteriorating the printing quality. Therefore, in order to prevent such a pressure interference between nozzles as described above, an inkjet head having a diaphragm portion for buffering variation in pressure in the reservoir is provided on the nozzle substrate is proposed (for example, see Patent Document 1).

[Patent Document 1] Japanese Unexamined Patent Application Publication No. 11-115179

However, according to the inkjet head in the related art, as shown in Patent Document 1, since the reservoir is formed on the same substrate (cavity substrate) as the discharge chamber, it is difficult to provide a pressure variation buffering member, that is, a diaphragm portion on the same substrate as the reservoir in view of securing the capacity of the reservoir. Although the diaphragm portion is formed on the nozzle substrate from these reasons, since a portion of low strength is exposed outside in this structure, reduction of the thickness of the diaphragm portion is limited, and a protection cover or the like is additionally required.

### SUMMARY

An advantage of some aspects of the invention is to provide a liquid drop discharge head in which the density of nozzles can be increased, and pressure interference between the nozzles can be prevented, and a method of manufacturing the same.

In order to solve the above-described problem, a liquid drop discharge head of four-layer structure according to an aspect of the invention includes a nozzle substrate having a plurality of nozzle holes, a cavity substrate having a plurality of independent discharge chambers that communicate with the respective nozzle holes and generate a pressure in the chambers for discharging liquid drops through the nozzle holes, and a reservoir substrate forming a reservoir space that communicates commonly with the discharge chambers, wherein the reservoir substrate has a diaphragm portion provided by reducing the thickness of a part of a wall surface forming the reservoir space.

In the liquid drop discharge head according to an aspect of the invention, since the diaphragm portion and the discharge chambers are provided on the different substrates (the reservoir substrate and the cavity substrate), the capacity of the reservoir can be secured, and the diaphragm portion can be provided therein. Therefore, the density of the nozzles can be increased, and the pressure interference between the nozzles can be prevented by the diaphragm portion provided on a part of the wall surface forming the reservoir space.

Preferably, the diaphragm portion is formed on the side of a joint surface of the reservoir substrate with respect to the cavity substrate (also referred to as C-surface).

By forming the diaphragm portion on the side of the C-surface of the reservoir substrate, the surface area of the diaphragm portion can be increased, and hence the pressure buffering effect of the diaphragm portion can be increased.

In this case, the diaphragm portion is covered by the cavity substrate, and is blocked from the outside by being covered by the cavity substrate.

In this configuration, since an external force is not applied directly to the diaphragm portion, the thickness of the diaphragm portion can be reduced, and a specific protective member such as a protection cover is not necessary.

Preferably, the diaphragm portion is formed on the side of a joint surface of the reservoir substrate with respect to the nozzle substrate (also referred to as N-surface).

The diaphragm portion may be provided on the side of the N-surface of the reservoir substrate opposite from the C-surface. In this case as well, the surface area of the diaphragm portion can be increased, and the pressure buffering effect of the diaphragm portion can be enhanced.

Preferably, the diaphragm portion is covered by the nozzle substrate, and is blocked from the outside.

In this configuration, as described above, since an external force is not applied directly to the diaphragm portion, the thickness of the diaphragm portion can be reduced, and a specific protective member such as a protection cover is not necessary.

Preferably, the diaphragm portion has a closed space portion on the opposite side from the reservoir space.

In this space portion, the diaphragm portion can be oscillated and displaced.

Preferably, the space portion can be defined by a recess formed on the surface of the reservoir substrate opposite from the reservoir space.

Preferably, the diaphragm portion can be formed of a boron diffused layer obtained by selectively diffusing boron.

By forming only the diaphragm portion of the boron diffused layer, an etching stop effect acts, and hence the diaphragm portion with high degree of thickness accuracy can be formed.

Preferably, the reservoir substrate is formed of silicon substrate of (100) in plane direction.

With the silicon substrate of (100) in the plane direction, since the thickness is uniform in a wet etching process of the reservoir substrate and hence an etching surface having less roughness can be formed, the reservoir space having a uniform depth and the diaphragm portion having a uniform thickness can be formed.

Preferably, the liquid drop discharge head according to an aspect of the invention is formed by joining an electrode substrate having individual electrodes formed in recesses for electrostatically driving oscillating plates constituting the bottom portions of the discharge chambers with the cavity substrate via an insulating film.

Accordingly, the liquid drop discharge head of an electrostatic drive system can be formed, and the liquid drop discharge head with high density, less pressure interference between nozzles, and preferable discharging property can be provided.

A method of manufacturing a liquid drop discharge head according to an aspect of the invention is such that a diaphragm portion is formed by etching a portion corresponding to the diaphragm portion from one of the surfaces of the silicon substrate by a required depth, and processing a recess which corresponds to a reservoir space from the surface of the silicon substrate on the opposite side by wet etching.

With the method of manufacturing according to an aspect of the invention, effective processing is achieved by etching the plurality of reservoirs having the diaphragm, a large surface area and a large depth simultaneously.

A method of manufacturing a liquid drop discharge head according to an aspect of the invention is such that a diaphragm portion is formed by etching a portion corresponding to the diaphragm portion from one of the surfaces of the silicon substrate by a required depth, selectively diffusing boron to a recess formed thereby, and processing a recess which corresponds to a reservoir space from the surface of the silicon substrate on the opposite side by wet etching.

With the method of manufacturing according to an aspect of the invention, the boron diffused area is extremely lowered in etching rate in the wet etching, and hence the thickness of the diffused area is controlled, and hence the extremely thin diaphragm portion with high degree of thickness accuracy can be formed.

Preferably, the wet etching is started with a concentration which provides a high etching rate and changed to a concentration which provides a low etching rate halfway in the process of wet etching of the recess which corresponds to the reservoir space.

Accordingly, both the processing efficiency of the reservoir space and the thickness accuracy of the diaphragm portion can be improved.

### BRIEF DESCRIPTION OF THE DRAWINGS

FIG. 1 is an exploded perspective view showing a general configuration of an inkjet head according to a first embodiment of the invention;

FIG. 2 is a cross-sectional view of the inkjet head in an assembled state;

FIG. 3 is a plan view of a reservoir substrate of the inkjet head shown in FIG. 1;

FIG. 4 is a back view of the same reservoir substrate;

FIGS. 5A to 5D are cross-sectional views illustrating a manufacturing process of the reservoir substrate used for manufacturing the inkjet head according to the first embodiment;

FIGS. 6E to 6H are cross-sectional views illustrating the manufacturing process of the reservoir substrate continued from FIG. 5;

FIGS. 7A to 7F are cross-sectional views illustrating a manufacturing process showing a method of manufacturing the inkjet head according to the first embodiment;

FIGS. 8G to 8J are cross-sectional views of the manufacturing process continued from FIG. 7;

FIGS. 9K to 9M are cross sectional views of the manufacturing process continued from FIG. 8;

FIG. 10 is an exploded perspective view showing a general configuration of the inkjet head according to the first embodiment of the invention;

FIG. 11 is a cross-sectional view of the inkjet head in the assembled state;

FIG. 12 is a plan view of the reservoir substrate of the inkjet head in FIG. 10;

FIG. 13 is a back view of the reservoir substrate of the inkjet head in FIG. 10;

FIGS. 14A to 14E are cross-sectional views illustrating a manufacturing process of a reservoir substrate used for manufacturing an inkjet head according to a second embodiment; and

FIGS. 15F to 15I are cross-sectional views of the manufacturing process continued from FIG. 14.

### DESCRIPTION OF THE PREFERRED EMBODIMENTS

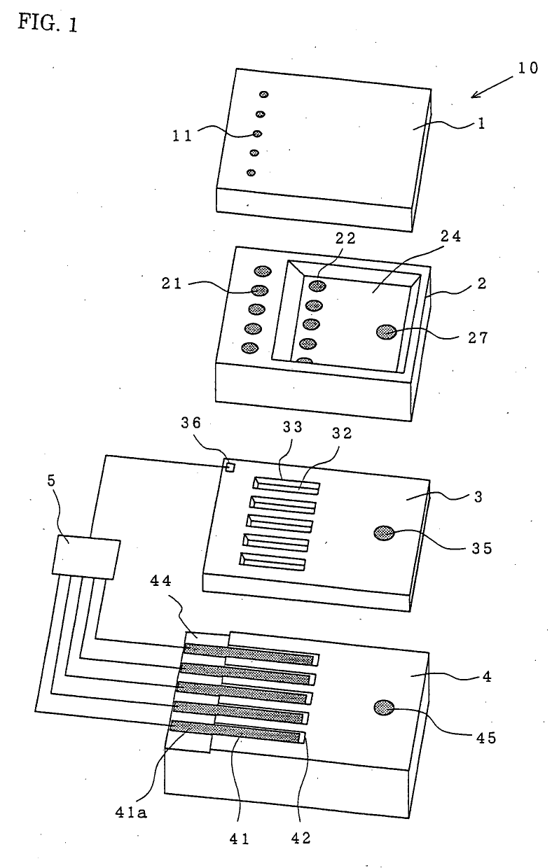

Referring now to the drawings, an embodiment of a liquid drop discharge head to which the invention is applied will be described. Referring here to FIG. 1 to FIG. 4, an inkjet head of a face discharge type in which ink drops are discharged from nozzle holes provided on the surface of a nozzle substrate will be described as an example of the liquid drop discharge head. The invention is not limited to the following structure and the shape shown in the drawings, and may be applied to a liquid drop discharge head of an edge discharge type in which ink drops are discharged from nozzle holes provided at the end portion of the substrate. An actuator exemplified here is of an electrostatic drive system, other drive types are also applicable.

### First Embodiment

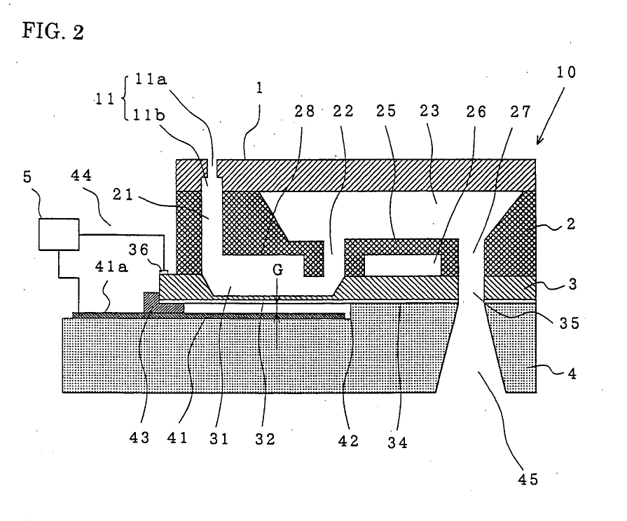

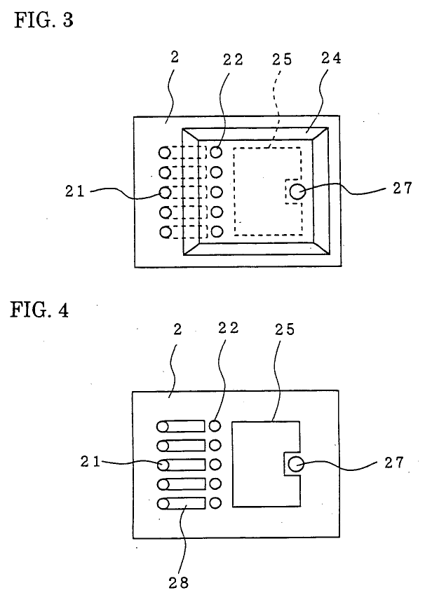

FIG. 1 is an exploded perspective view showing a general configuration of an inkjet head according to a first embodiment of the invention, and FIG. 2 is a cross-sectional view of the inkjet head in an assembled state. FIG. 3 and FIG. 4 are a plan view and a back view of a reservoir substrate as a component of the inkjet head. FIG. 1 and FIG. 2 show an inverted state from a state in which the inkjet head is normally used.

An inkjet head 10 (an example of the liquid drop discharge head) according to this embodiment shown in FIG. 1 and FIG. 2 does not have a three-layer structure in which three substrates, that is, a nozzle substrate, a cavity substrate and an electrode substrate, are adhered to each other as the inkjet head of a general inkjet head of the electrostatic drive system in the related art, but has a four-layer structure in which four substrates, that is, a nozzle substrate 1, a reservoir substrate 2, a cavity substrate 3 and an electrode substrate 4 are adhered to each other. In other words, a discharge chamber 31 and a reservoir space (which is also referred to as a reservoir simply) 23, are provided on the different substrates. Hereinafter, configurations of the respective substrate will be described in detail.

The nozzle substrate 1 is formed of a silicon substrate having a thickness of, for example, about 50 μm. The nozzle substrate 1 is formed with a number of nozzle holes 11 at a predetermined pitch. However, in FIG. 1, there are five nozzle holes 11 in one row for clarifying the description. The number or nozzle rows may be plural.

The nozzle holes 11 each include an injection port portion 11a of a smaller diameter and an introduction port portion 11b having a larger diameter than the injection port portion 11a so as to extend vertically with respect to the plane of the substrate and coaxially with respect to each other.

The reservoir substrate 2 is formed, for example, of a silicon substrate of, for example, about 180 μm in thickness and (100) in plane direction. The reservoir substrate 2 is provided with nozzle communication holes 21 each having a diameter slightly larger (equivalent to or larger than the diameter of the introduction port portion llb) so as to penetrate through the reservoir substrate 2 in the vertical direction and communicate independently with the respective nozzle holes 11. The reservoir substrate 2 is also formed with a recess 24 which corresponds to a common reservoir space (common ink chamber) 23 communicating with the respective nozzle communication holes 21 and the nozzle holes 11 via respective supply ports 22. The recess 24 extends in the direction of the plane, and is formed into a rectangular shape having a large surface area, and is opened on a surface which is to be joined with the nozzle substrate 1 (hereinafter referred to also as an N-surface). A diaphragm portion 25 is formed on a part of the bottom portion of the recess 24. A recess 26 is formed below the diaphragm portion 25, that is, on the surface of the side which is joined with the cavity substrate 3 (hereinafter, referred to also as a C-surface), so that the recess 26 defines a space portion which allows deformation of the diaphragm portion 25. The space portion 26 is closed by the cavity substrate 3 and is sealed.

In the bottom portion of the recess 24, which corresponds to the reservoir space 23, the above-described supply ports 22 and an ink supply hole 27 for supplying ink to the reservoir space 23 from the outside are formed at positions avoiding the diaphragm portion 25 by a through hole.

In addition, the C-surface of the reservoir substrate 2 is formed with narrow groove-shaped second recesses 28 which constitute a part of each discharge chamber 31 of the cavity substrate 3, describe below. The second recesses 28 are provided for preventing increase of flow resistance in each discharge chamber 31 by thinning the cavity substrate 3. The second recesses 28, however, may be omitted.

Although not shown, the reservoir substrate 2 is formed with an ink protection film formed of, for example, a thermally-oxidized film (SᵢO₂ film) for preventing corrosion of silicon by ink over the entire surface thereof.

Since the nozzle communication holes 21 penetrating through the reservoir substrate 2 are provided coaxially with the nozzle holes 11 of the nozzle substrate 1, straight advancement property of discharged ink drop is achieved, and hence the discharging characteristic is remarkably improved. In particular, since minute ink drops can be landed to an aimed position, delicate tone change can be reproduced faithfully without causing color drift or the like, and hence a clearer and higher quality image can be obtained.

The cavity substrate 3 is formed of a silicon substrate of, for example, about 30 μm in thickness. The cavity substrate 3 is provided with first recesses 33 which correspond to the discharge chambers 31 communicating with the respective nozzle communication holes 21 independently. The first recesses 33 and the above-described second recesses 28 define the independently partitioned discharge chambers 31. The bottom wall of the discharge chamber 31 (the first recesses 33) constitutes oscillating plates 32. The oscillating plates 32 act as electrodes facing to individual electrode 41. It can be configured by a boron diffusion layer formed by diffusing high-density boron on the silicon. Since an etching stop effect acts by employing the boron diffusion layer, thickness or surface roughness of the oscillation plates 32 can be adjusted with high degree of accuracy.

At least the lower surface of the cavity substrate 3 is formed, for example, with an insulation film 34 formed of SᵢO₂ film by a thickness of, for example, 0.1 μm by plasma CVD (Chemical Vapor Deposition) using TEOS. (Tetraethylorthosilicate Tetraethoxysilane) as basic ingredient. The insulation film 34 is provided for preventing electric breakdown or short circuit when the inkjet head 10 is being driven. The cavity substrate 3 is formed with an ink protection film (not shown) in the same type as the reservoir substrate 2 on the upper surface thereof. The cavity substrate. 3 is provided with an ink supply hole 35 which communicates with the ink supply hole 27 of the reservoir substrate 2.

The electrode substrate 4 is formed of a glass substrate of, for example, about 1 mm in thickness. Among others, a borosilicate heat-resisting hard glass having a coefficient of thermal expansion close to that of the silicon substrate for the cavity substrate 3 is suitable. By using the borosilicate heat-resisting hard glass, since the coefficients of thermal expansion are close to each other, a stress generated between the electrode substrate 4 and the cavity substrate 3 at the time of anode-joining the electrode substrate 4 and the cavity substrate 3 can be reduced, and consequently, the electrode substrate 4 and the cavity substrate 3 can be joined firmly without causing a problem such as separation.

The electrode substrate 4 is provided with recesses 42 on the surface at positions corresponding to the respective oscillating plates 32 of the cavity substrate 3. The recesses 42 are formed by etching by about 0.3 μm in depth. The bottom surfaces of the respective recesses 42 each are formed with an individual electrode 41 formed of ITO (Indium Tin Oxide) of about 0.1 μm in thickness by spattering. Therefore, a gap G formed between the oscillating plate 32 and the individual electrode 41 (clearance) is determined by the depth of the recess 42, the thickness of the individual electrode 41 and insulation film 34 that covers the oscillating plate 32. The gap (electrode-front gap) G affects significantly the discharging characteristic of the inkjet head. In the case of this embodiment, the electrode-front gap G is 0.2 μm. The opening end of the electrode-front gap G is hermetically sealed by a sealing member 43 formed of the epoxy adhesive agent or the like. Accordingly, entry of foreign substances or moisture into the electrode-front gap can be prevented, and high reliability of the inkjet head 10 can be maintained.

The material of the individual electrode 41 is not limited to ITO, and may be IZO (Indium Zinc Oxide), or metal such as gold or cooper. However, ITO is generally used because it is transparent and hence the state of abutment of the oscillating plate can be checked easily.

A terminal 41a of the individual electrode 41 is exposed to an electrode take-out portion 44 formed by opening the end of the reservoir substrate 2 and the cavity substrate 3, and a flexible wiring substrate (not shown) on which a drive control circuit 5 such as a driver IC is connected to the terminals 41a of the respective individual electrodes 41 and a common electrode 36 provided at an end of the cavity substrate 3.

An ink supply hole 45 to be connected to the ink cartridge (not shown) is provided on the electrode substrate 4. The ink supply hole 45 communicates with the reservoir 23 via the ink supply hole 35 provided on the cavity substrate 3 and the ink supply hole 27 provided on the reservoir substrate 2.

Here, the operation of the inkjet head 10 configured as described above will be described in brief.

In the inkjet head 10, ink in the ink cartridge (not shown) provided outside is supplied to the reservoir 23 through the ink supply holes 45, 35 and 27, and the ink is filled from the respective supply ports 22 through the respective discharge chambers 31 and the nozzle communication hole 21 up to the distal end of the nozzle hole 11. The drive control circuit 5 such as a drive IC for controlling the operation of the inkjet head 10 is connected between the respective individual electrodes 41 and the common electrode 36 provided on. the cavity substrate 3. Therefore, when drive signal (pulse electrode) is supplied to the individual electrode 41 by the drive control circuit 5, the pulse voltage is applied from the drive control circuit 5 to the individual electrode 41, so that the individual electrodes 41 are positively charged, while the oscillating plate 32 corresponding thereto is negatively charged. At this time, electrostatic force (Coulomb force) is generated between the individual electrode 41 and the oscillating plate 32, and hence the oscillating plate 32 is attracted and thus bent toward the individual electrode 41 by the electrostatic force. Consequently, the capacity of the discharge chamber 31 increases. Subsequently, when the pulse voltage is turned OFF, the electrostatic force described above is distinguished, and the oscillating plate 32 is restored by its resilient force. At this time, since the capacity of the discharge chamber 31 is abruptly reduced, part of the ink in the discharge chamber 31 passes through the nozzle communication hole 21 by the pressure applied thereby and is discharged through the nozzle hole 11 as an ink drop. When the pulse voltage is applied again, the oscillating plate 32 is bent toward the individual electrode 41, and hence the ink is replenished from the reservoir 23 through the supply port 22 into the discharge chamber 31.

With the configuration of the inkjet head 10 according to the first embodiment, when the inkjet head 10 as described above is driven, the pressure in the discharge chamber 31 is also transmitted to the reservoir 23. At this time, since the diaphragm portion 25 is provided on the part of the bottom portion of the reservoir 23, when the reservoir 23 is at the positive pressure, the diaphragm portion 25 is bent downward in the space portion of the recess 26, and in contrast, when the reservoir 23 is in the negative pressure, the diaphragm portion 25 is bent upward, so that variations in pressure in the reservoir 23 can be alleviated, and the pressure interference between nozzles can be prevented. Therefore, problems such as leak of ink from the non-driven nozzle other than the driven nozzle or reduction of discharge amount required for discharging from the driven nozzle can be avoided.

Since the diaphragm portion 25 is provided on the bottom portion of the reservoir 23, the surface area of the diaphragm portion 25 can be increased, and hence the pressure buffering effect can be increased.

In addition, since the diaphragm portion 25 is covered by the cavity substrate 3 and is not exposed to the outside, the diaphragm portion 25 formed of the thin film member can be reliably protected from the external force, and specific protective members such as a protective cover is not necessary at all. Therefore, downsizing and reduction of the cost of the inkjet head 10 are achieved.

Since the diaphragm portion 25 has a large surface area as described above, it can be displaced (oscillated) reliable in the sealed space portion 26. It is also possible to provide a small air-ventilation hole (not shown) which communicates from the outside into the space portion 26 on the cavity substrate 3 and the electrode substrate 4 as needed.

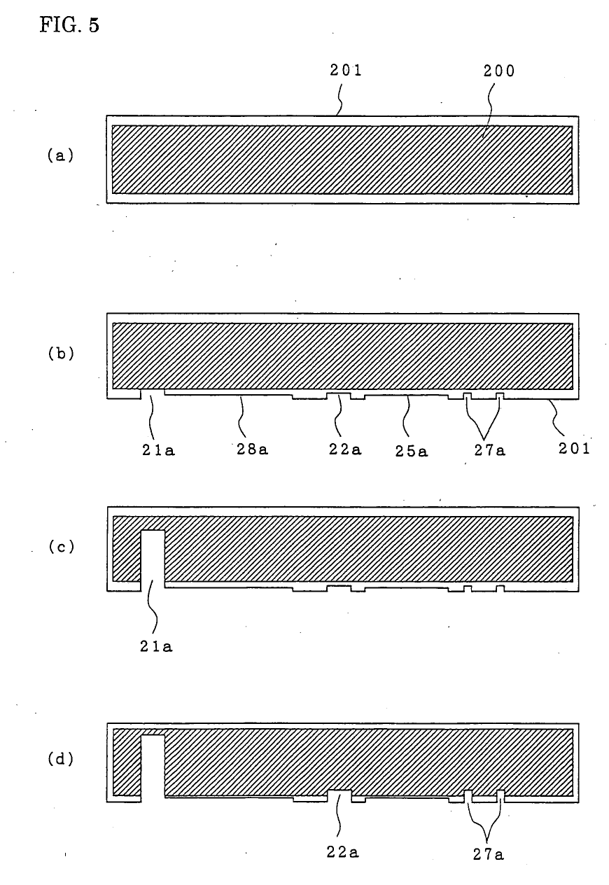

Referring now to FIG. 5 to FIG. 9, a method of manufacturing the inkjet head 10 according to the first embodiment will be described. The values of the thickness of the substrate or the depth of etching, the temperature, the pressure, and so on shown below are illustrative only, and the invention is not limited by these values.

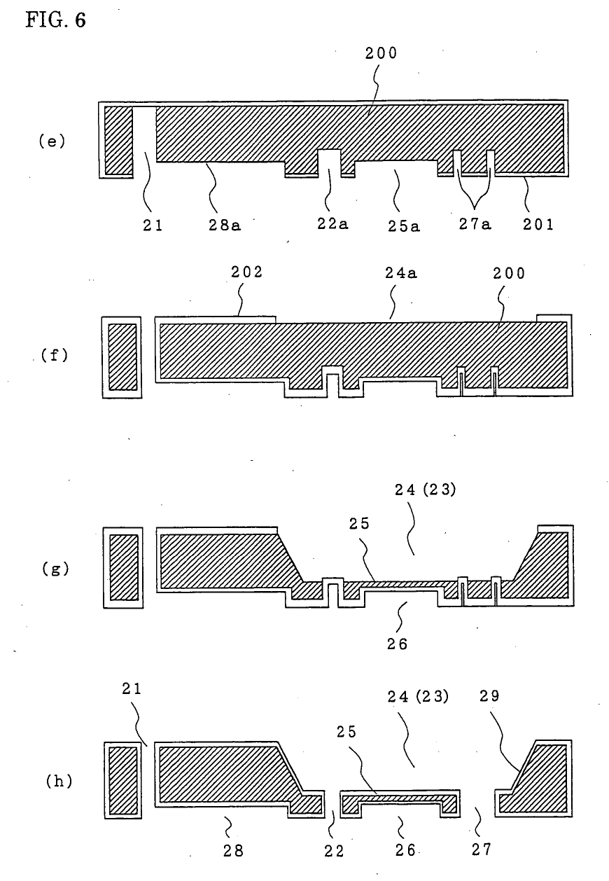

Firstly, a method of manufacturing the reservoir substrate used for manufacturing the inkjet head according to the first embodiment will be described referring to process cross-sectional views in FIG. 5 and FIG. 6.

A silicon substrate 200 of a plane direction (100), and a thickness of 180 μm is prepared. A SᵢO₂ film 201 of a thickness of 1.6 μm is formed over the entire surface of the silicon substrate 200 (FIG. 5A). The SᵢO₂ film 201 is formed by setting the silicon substrate 200 in, for example, a thermal oxidation device and performing thermal oxidation in an atmosphere of a mixture of oxygen and water vapor at an oxidation temperature of 1075° C. for 8 hours. The SᵢO₂ film 201 is used as an anti-etching material for silicon.

Subsequently, the SᵢO₂ film on the joint surface of the silicon substrate 200 with respect to the cavity substrate (hereinafter referred to as a C-surface) is coated with a resist, and then portions 21a, 28a, 22a, 27a and 25a corresponding to the nozzle communication holes 21, the second recesses 28, the supply ports 22, the outer peripheral portion of the ink supply hole 27, and the diaphragm portion 25 are patterned by photolithography and etched (FIG. 5B). At this time, etching is performed using, for example, buffer hydrofluoric acid solution obtained by mixing hydrofluoric acid solution and ammonium fluoride solution so that the remaining film thickness of the SᵢO₂ film 201 at the respective portions 21a, 28a, 22a, 27a and 25a on the C-surface becomes the following relation. Remaining thickness of the SᵢO₂ film 201: the portions 21a of the nozzle communication holes=0<the portions 22a of the supply ports=the outer peripheral portion 27a of the ink supply hole<the portions 28a of the second recesses=the portion 25a of the diaphragm

Then, the resist is peeled off.

Subsequently, the portion 21a of the C-surface corresponding to the nozzle communication hole 21 is applied with anisotropic dry etching by a thickness of about 150 μm by ICP (Inductively Coupled Plasma) dry etching (FIG. 5C). In this case, for example, C₄F₈ (carbon tetrafluoride) and SF₆ (sulfur entafluoride) may be alternately used as an etching gas. Here, C₄F₈ is used for protecting the side surfaces of the hole portions 21a so that etching does not proceed toward the side surfaces of the hole portions 21a, and SF₆ is used for encouraging the etching vertically of the hole portions 21a.

Then, the portions 22a corresponding to the supply ports 22 and on the portion 27a corresponding to the outer peripheral portion of the ink supply hole 27 of the SᵢO₂ film 201 are etched by an adequate amount to open these portions 22a, 27a, and then anisotropic dry etching is applied thereto by a depth about 15 μm by the ICP dry etching using the above-described two types of etching gas (FIG. 5D).

Subsequently, the portions 28a corresponding to the second recesses 28 and the portion 25a corresponding to the diaphragm portion 25 of the SᵢO₂ film 201 are etched by an adequate amount to open these portions 28a, 25a, and then the anisotropic dry etching is applied thereto by a depth about 25 μm by the ICP dry etching using the above-described two types of etching gas (FIG. 6E). At this time, the hole portions 21a corresponding to the nozzle communication holes 21 are further etched completely through the silicon substrate 200, so that the nozzle communication holes 21 are formed.

Subsequently, after having peeled the above-described SᵢO₂ film completely off, another SᵢO₂ film 202 of a thickness of 1.1 μm is formed again on the entire surface of the silicon substrate 200 by thermal oxidation. Then, the SᵢO₂ film 202 on the joint surface of the silicon substrate 200 with respect to the nozzle substrate is coated with a resist, and the portion 24a corresponding to the recess 24 which corresponds to the reservoir space 23 is patterned by photolithography and etched (FIG. 6F). Then, the resist is peeled off.

Then, the silicon substrate 200 is soaked in potassium hydroxide solution, and wet etching is applied to the recess 24 which corresponds to the reservoir space 23 by a depth of about 150 μm (FIG. 6G). Consequently, the thickness of the diaphragm portion 25 becomes about 5 μm. In this wet etching process, it is preferable to use the potassium hydroxide solution having a concentration which provides a high etching rate (for example, 35 wt %) at the beginning, and then change the potassium hydroxide solution to that having a concentration which provides a low etching rate (for example, 3 wt %) halfway. Consequently, the diaphragm portion 25 is prevented from becoming a rough surface, and improvement of the surface accuracy and prevention of surface defect are effectively achieved.

Lastly, after having peeled off the SᵢO₂ film 202 completely, an ink protection film 29 of a thickness of 0.1 μm is formed on the entire surface of the silicon substrate 200 again by dry oxidation (FIG. 6H). When the SᵢO₂ film 202 is peeled off, the ink supply hole 27 becomes a through-hole.

With the procedure shown thus far, the respective portions 21 to 28 of the reservoir substrate 2 are formed.

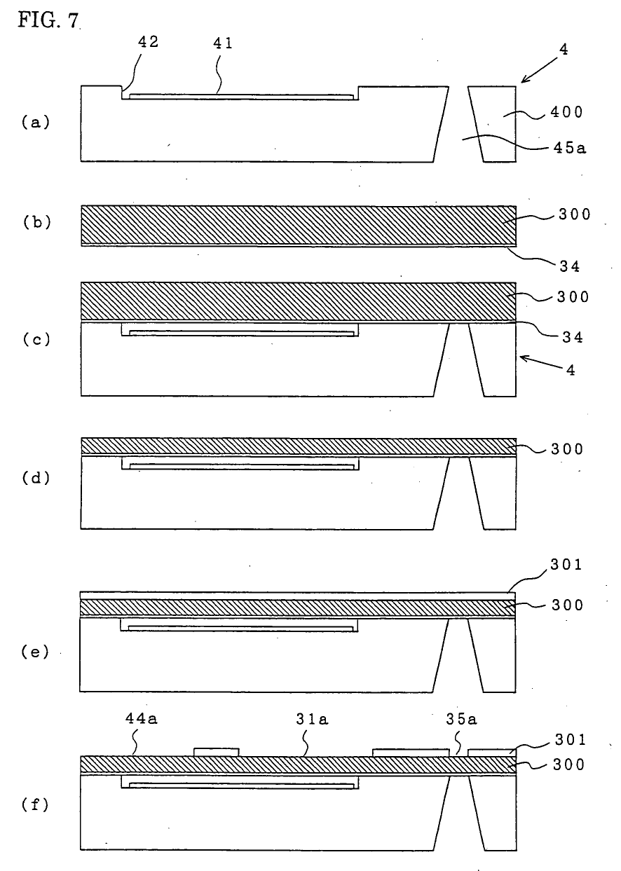

Referring now to FIG. 7 to FIG. 9, a method of manufacturing the inkjet head according to the first embodiment will be described.

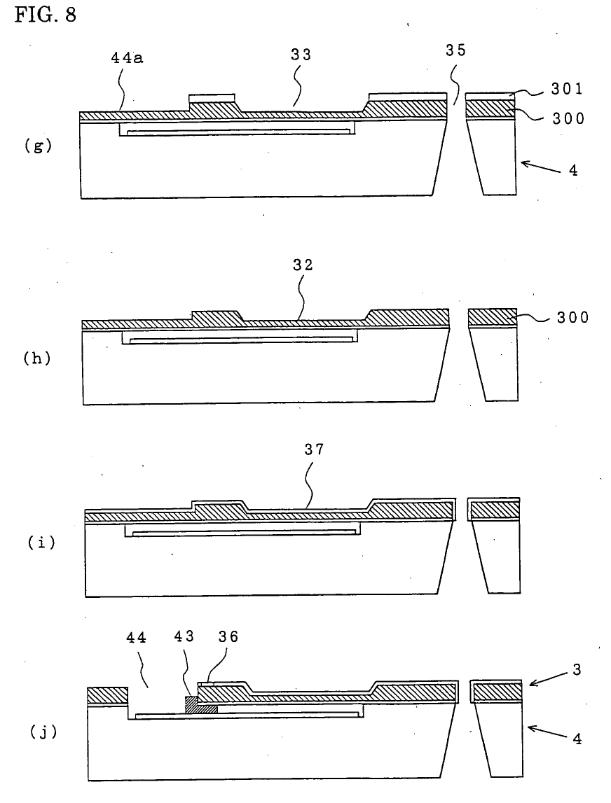

Here, referring to FIG. 7 and FIG. 8, a method of joining a silicon substrate 300 to the electrode substrate 4 and then manufacturing the cavity plate 3 from the silicon substrate 300 will be described briefly.

The electrode substrate 4 is manufactured in the following manner. Firstly, etching is performed with hydrofluoric acid using an etching mask such as gold or chrome on a glass substrate 400 formed of borosilicate glass of about 1 mm in thickness to form the recesses 42. The recesses 42 each have a groove-shape slightly larger than the shape of the individual electrode 41, and a plurality of recesses 42 are formed corresponding to each individual electrode 41.

Then, the individual electrode 41 is formed from ITO (Indium Tin Oxide) by, for example, spattering in the recess 42.

Then, a hole portion 45a which corresponds to the ink supply hole 45 is formed by blasting or the like, so that the electrode substrate 4 is manufactured (FIG. 7A).

Then, the silicon substrate 300 which is applied with a surface treating of about 220 μm in thickness and a process of removing an affected layer on the surface (a surface preparation) is prepared, and the insulation film 34 formed of the SᵢO₂ film of 0.1 μm in thickness is formed on. one surface of the silicon substrate 300 by plasma CVD (Chemical Vapor Deposition) using TEOS as a basic ingredient (FIG. 7B). Formation of the insulation film 34 is performed, for example, under the condition of 360° C. in temperature, 250W in high-frequency output, 66.7 Passenger constraining apparatus in pressure (0.5 Torr), a TEOS flow rate 100 cm³/min (100 sccm) in gas flow rate, and 1000 cm³/min (1000 sccm) in oxygen flow rate. The silicon substrate 300 is preferably the one having a boron doped layer (not shown) of a required thickness.

Then, the silicon substrate 300 is adhered to the electrode substrate 4 on which the individual electrodes 41 are manufactured as shown in FIG. 7A by anode joining via the insulation film 34 (FIG. 7C). The anode joining is performed by heating the silicon substrate 300 and the electrode substrate 4 to 360° C., connecting a negative pole to the electrode substrate 4 and a positive pole to the silicon substrate 300, and applying a voltage of 800v.

Then, the surface of the silicon substrate 300 obtained by the anode-joining is grinded by, for example, a back grinder or a polisher, and then the affected layer is removed therefrom by etching the surface by 10 to 20 μm with, for example, potassium hydroxide solution until the thickness becomes, for example, 30 μm (FIG. 7D).

Then, a TEOS oxidized film 301, which serves as an etching mask, of about 1.0 μm in thickness is formed on the surface of the thinned silicon substrate 300 by, for example, the plasma CVD (FIG. 7E).

Then, the surface of the TEOS oxidized film 301 is coated with a resist (not shown), the resist is patterned by photolithography, and the TEOS oxidized film 301 is etched, so as to open the portions 31a, 35a, 44a corresponding to the discharge chambers 31, the ink supply hole 35 and the electrode take-out portion 44 (FIG. 7F). Then, the resist is peeled off after opening these portions.

Then, the first recesses 33 which corresponds to the discharge chambers 31 and a through hole which corresponds to the ink supply hole 35 are formed on the silicon substrate 300 thinned by performing etching on the substrate after the anode-joining with potassium hydroxide solution (FIG. 8G). At this time, the portion 44a which corresponds to the electrode take-out portion 44 is not penetrated completely, and is kept simply to be reduced in substrate thickness. The thickness of the TEOS etching mask 301 is also reduced. In this etching process, etching is performed first by using the potassium hydroxide solution having a concentration of 35 wt % until the remaining thickness of the silicon substrate 300 becomes, for example, 5 μm, and then by switching the potassium hydroxide solution to that having a concentration of 3 wt %. Accordingly, an etching-stop effect acts sufficiently, and hence the surfaces of the oscillating plates 32 are prevented from becoming rough and an accurate thickness of 0.80±0.05 μm can be achieved. The etching-stop effect is defined by a state in which air-bubbles generated from the etching surface is stopped, and in the actual wet etching, etching is determined to be stopped by the stop of generation of air-bubbles.

Then, after having finished the etching, the resist is peeled off.

After having finished the etching of the silicon substrate 300, etching with the hydrofluoric acid solution is performed to remove the TEOS oxidized film 301 formed on the upper surface of the silicon substrate 300 (FIG. 8H).

Subsequently, the surface of the silicon substrate 300 formed with the first recesses 33 which correspond to the discharge chambers 31 is formed with an ink protection film 37 formed of TEOS film by, for example, a thickness of 0.1 μm by the plasma CVD (FIG. 8I).

Then, the electrode take-out portion 44 is opened by RIE (Reactive Ion Etching) or the like. The opened end of the electrode-front gap between the oscillating plates 32 and the individual electrodes 41 are sealed hermetically with a sealing member 43 such as epoxy resin or the like (FIG. 8J). The common electrode 36 formed of a metallic electrode such as Pt (platinum) is formed at the end of the surface of the silicon substrate 300 by spattering.

In the procedure described thus far, the cavity substrate 3 is manufactured from the silicon substrate 300 in a state of being joint with the electrode substrate 4.

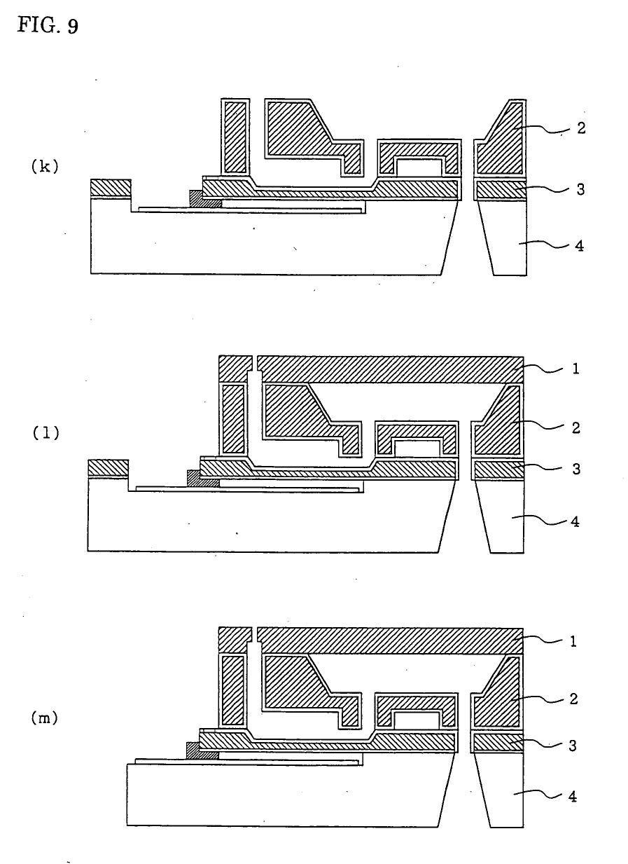

Then, the reservoir substrate 2 formed with the nozzle communication holes 21, the supply ports 22, the reservoir 23, the diaphragm portion 25 is adhered to the cavity substrate 3 with adhesive agent (FIG. 9K).

Finally, the nozzle substrate 1 formed with nozzle holes 11 in advance is adhered on the reservoir substrate 2 with adhesive agent (FIG. 9L). Then, the main body of the inkjet head 10 shown in FIG. 2 is manufactured by separating the same into the individual heads by dicing (FIG. 9M).

As described above, according to the method of manufacturing the inkjet head in this embodiment, since portions such as the discharge chambers or the like are formed after having joined the silicon substrate 300 and the electrode substrate 4, the silicon substrate 300 can be handled easily, and hence the possibility of breakage of the substrate can be reduced, and the dimension of the substrate can be increased. When the size of the substrate can be increased, a number of inkjet head can be obtained from one piece of substrate, and hence productivity can be improved.

### Second Embodiment

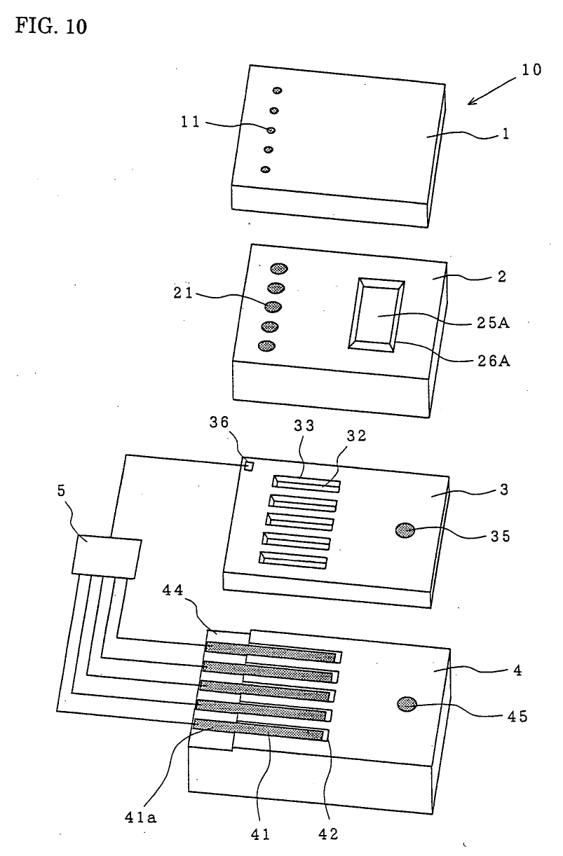

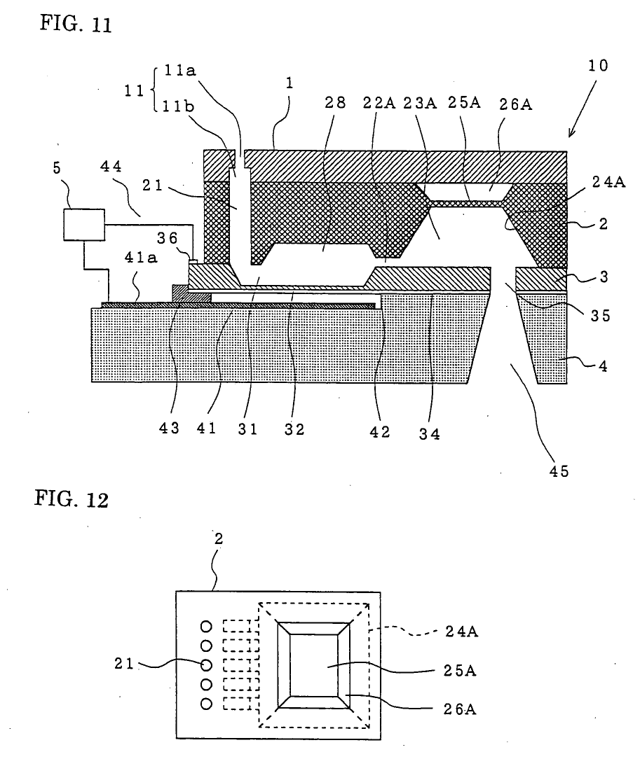

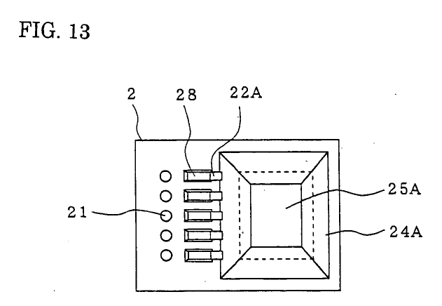

FIG. 10 is an exploded perspective view showing a general configuration of the inkjet head 10 according to a second embodiment; FIG. 11 is a cross-sectional view of the inkjet head in an assembled state; and FIG. 12 and FIG. 13 are a plan view and a back view of the reservoir substrate of the inkjet head in FIG. 10, respectively.

The inkjet head 10 according to the second embodiment includes a diaphragm portion 25A on the reservoir substrate 2 formed of a silicon substrate of a plane direction (100) provided on the N-surface (the joined surface with respect to the nozzle substrate 1) of the reserve substrate 2 in contrast to the first embodiment. In other words, a recess 24A which corresponds to a reservoir space 23A (see FIG. 11 to FIG. 13) is opened toward the C-surface (the joined surface with respect to the cavity substrate 3), and a recess 26A which corresponds to a space portion for allowing upward displacement of the diaphragm portion 25A is opened toward the N-surface of the reservoir substrate 2. The diaphragm portion 25A is formed of a boron diffused layer obtained by diffusing boron selectively as shown in the drawing showing a process of manufacturing the reservoir substrate 2 described later, thereby being configured with a thin-film portion with high degree of thickness accuracy. However, the diaphragm portion 25A is not limited to the one formed of the boron diffused layer.

In the second embodiment, the nozzle substrate 1, the cavity substrate 3 and the electrode substrate 4 except for the reservoir substrate 2 have the same configuration as in the first embodiment, and hence the same parts are represented by the same reference numerals and description will be omitted.

In this reservoir substrate 2, a cylindrical nozzle communication holes 21 which communicate with the nozzle holes 11 on the nozzle substrate 1 are formed in the same manner. The second recesses 28 that constitute a part of the respective discharge chambers 31 and the recess 24A which corresponds to the reservoir space 23A communicate with respect to each other via supply ports 22A of the thin groove-shape. The ink supply hole 35 provided on the cavity substrate 3 opens on the opening surface of the recess 24A.

According to the inkjet head 10 according to the second embodiment, since the diaphragm portion 25A provided on the bottom portion of the reservoir space 23A has a large surface area and oscillates in the vertical direction when the inkjet head 10 is being driven, the same effect as the first embodiment can be achieved, and the pressure interference between nozzles can be prevented. In addition, since the diaphragm portion 25A is covered by the nozzle substrate 1, it is reliably protected from the external force, and hence a specific protective cover or the like is not necessary.

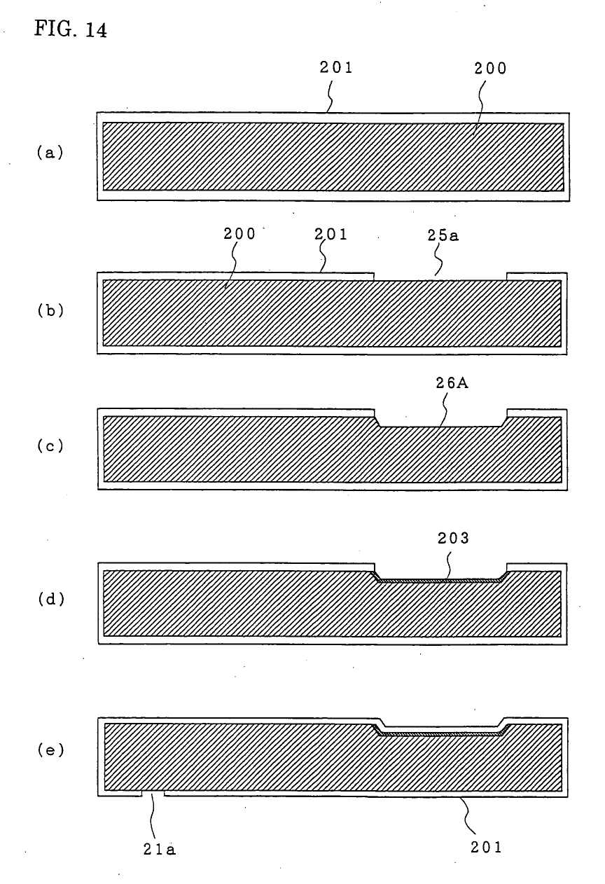

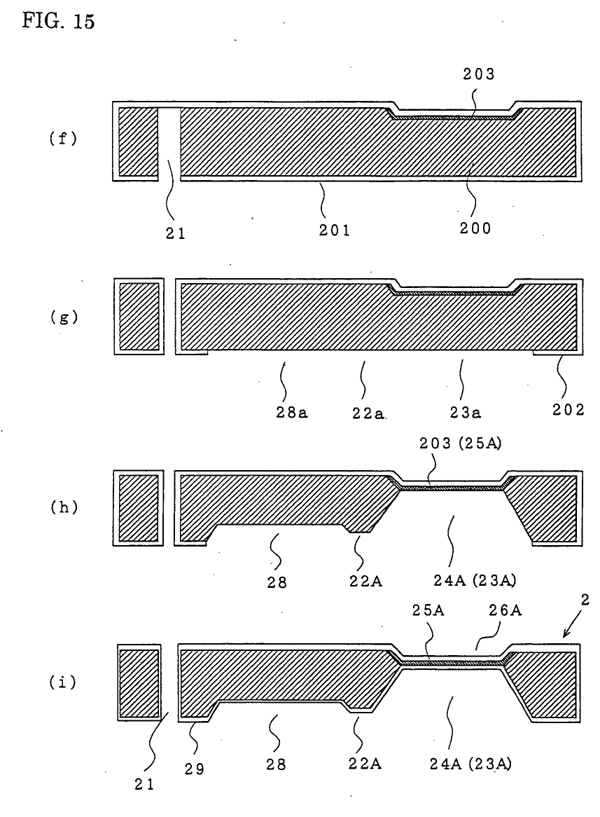

Referring now to the process cross-sectional view in FIG. 14 and FIG. 15, a method of manufacturing the reservoir substrate used for manufacturing the inkjet head according to the second embodiment will be described.

A silicon substrate 200 of a plane direction (100), and a thickness of 180 μm is prepared, and a SᵢO₂ film 201 of a thickness of 1 μm is formed over the entire surface of the silicon substrate 200 (FIG. 14A). The SᵢO₂ film 201 is formed by setting the silicon substrate 200 in, for example, a thermal oxidation device and performing thermal oxidation in an atmosphere of a mixture of oxygen and water vapor at an oxidation temperature of 1075° C. for four hours. The SᵢO₂ film 201 is used as an anti-etching material for silicon.

Subsequently, the SᵢO₂ film on the N-surface side of the silicon substrate 200 is coated with a resist, and the portion 25a corresponding to the diaphragm portion 25A is patterned by photolithography and opened by etching (FIG. 14B). Then, the resist is peeled off.

Subsequently, the silicon substrate 200 is soaked in potassium hydroxide solution, and wet etching is applied to the portion 25a corresponding to the diaphragm portion 25A by a depth of about 25 μm (FIG. 14C). Accordingly, the recess 26A corresponding to the diaphragm portion 25A is formed.

Subsequently, a boron of a high concentration is selectively diffused only on the recess portion 26 (FIG. 14D) by an adequate amount. The thickness of a boron diffused layer 203 obtained by diffusing boron become the same thickness as the diaphragm portion 25A in the last result, and can be adjusted to a desired thin thickness (5 μm or less).

Subsequently, the SᵢO₂ film 201 on the side of the C-surface of the silicon substrate 200 is coated with a resist, and the portions 21a corresponding to the nozzle communication holes 21 are patterned by photolithography and opened by etching (FIG. 14E). Subsequently, the resist is peeled off.

Then, the portions 21a corresponding to the nozzle communication holes 21 on the C-surface is applied with anisotropic dry etching until it is completely penetrated through the silicon substrate 200 by ICP dry etching (FIG. 15F). In this case, for example, C₄F₈ (carbon tetrafluoride) and SF₆ (sulfur entafluoride) may be alternately used as an etching gas. Here, C₄F₈ is used for protecting the side surfaces of the hole portions so that etching does not proceed toward the side surfaces of the hole portions, and SF₆ is used for encouraging the etching vertically of the hole portion.

After having peeled all the SᵢO₂ film 201 completely off, another SᵢO₂ film 202 of a thickness of 1.1 μm is formed again on the entire surface of the silicon substrate 200 by thermal oxidation. Then, the SᵢO₂ film 202 on the side of the C-surface of the silicon substrate 200 is coated with a resist, and the portions 22a, 23a, and 28a corresponding respectively to the supply port 22A, the reservoir space 23A, and the second recess 28 are patterned by photolithography and opened by etching (FIG. 15G). At this time, patterning is made so that the pattern width of the respective portions becomes the following relation. Pattern width: reservoir portion 23a>the portions 28a of the second recesses>the portions 22a of the supply ports

Subsequently, the resist is peeled off.

Subsequently, the recess 24A which corresponds to the reservoir space 23A on the C-surface is formed by wet etching with potassium hydroxide solution (FIG. 15H). In this case, etching of the recess 24A which corresponds to the reservoir space 23A is stopped by the boron diffused layer 203, and the diaphragm portion 25A corresponding to the thickness of the boron diffused layer 203 is formed. In this wet etching process as well, it is preferable to use the two types of potassium hydroxide solution different in concentration as described above. In other words, it is also preferable to use the potassium hydroxide solution having a concentration which provides a high etching rate (for example, 35 wt %) at the beginning, and then change the potassium hydroxide solution to that having a concentration which provides a low etching rate (for example, 3 wt %) halfway. Since the second recesses 28 and the supply ports 22A are formed of a silicon substrate of (100) in plane direction, the etching is stopped at a depth corresponding to the opening width. In other words, the depths of the respective portions become the following relation. Reservoir space 23A>second recesses 28>supply ports 22A

Lastly, after having peeled the above-described SᵢO₂ film 202 off, an ink protection film 29 for a thickness of 0.1 μm is formed on the entire surface of the silicon substrate 200 again by dry oxidation (FIG. 15I). With the procedure shown thus far, the reservoir substrate 2 is manufactured.

Then, with a method as described in conjunction with FIG. 7 to FIG. 9 using the reservoir substrate 2, the inkjet head 10 according to the second embodiment can be manufactured.

According to the method of manufacturing the inkjet head 10 in the second embodiment, since the diaphragm portion 25A is formed of the boron diffused layer obtained by selectively diffusing boron, the diaphragm portion formed of a thin film which is high in thickness accuracy, good in surface accuracy, and has less surface defect can be formed.

The diaphragm portion 25 in the second embodiment can also be formed of the boron diffused layer obtained by selectively diffusing boron as in the case of the first embodiment.

The space portion in which the diaphragm portions 25, 25A can be displaced must simply be formed between the reservoir substrate 2 and the joined surface with respect to the cavity substrate 3 or the nozzle substrate 1, and the recesses 26, 26A must simply be formed on one or both of the substrates.

In the embodiments shown above, the inkjet head of the electrostatic drive system and the method of manufacturing the same have been described. However, the invention is not limited to the above-described embodiments and may be modified within the scope of the idea of the invention. For example, the invention can also be applied to an inkjet head of a drive system other than the electrostatic drive system. In the case of the piezoelectric system, the piezoelectric may be adhered to the bottom portions of the respective discharge chambers instead of the electrode substrate, and in the case of the bubble system, heat generating elements may be provided in the respective discharge chambers. By changing the liquid-state material discharged from the nozzle holes, the invention can be used for various liquid drop discharge device for manufacturing a color filter for a liquid crystal display, formation of a light-emitting portion of an organic EL display device, or manufacturing of a microarray for biomolecular used for genetic screening, in addition to the inkjet printer.

What is claimed is:

1. A liquid drop discharge head of four-layer structure comprising: a nozzle substrate having a plurality of nozzle holes;
a cavity substrate having a plurality of independent discharge chambers that communicate with the respective nozzle holes and generate a pressure in the chambers for discharging liquid drops through the nozzle holes; and
a reservoir substrate forming a reservoir space that communicates commonly with the discharge chambers, wherein the reservoir substrate has a diaphragm portion provided by reducing the thickness of a part of a wall surface forming the reservoir space.

2. The liquid drop discharge head according to claim 1, wherein the diaphragm portion is formed on the side of a joint surface of the reservoir substrate with respect to the cavity substrate.

3. The liquid drop discharge head according to claim 2, wherein the diaphragm portion is covered by the cavity substrate and is blocked from outside.

4. The liquid drop discharge head according to claim 1, wherein the diaphragm portion is formed on the side of a joint surface of the reservoir substrate with respect to the nozzle substrate.

5. The liquid drop discharge head according to claim 4, wherein the diaphragm portion is covered by the nozzle substrate, and is blocked from the outside.

6. The liquid drop discharge head according to claim 1, wherein the diaphragm portion has a closed space portion on the opposite side from the reservoir space.

7. The liquid drop discharge head according to claim 6, wherein the space portion is defined by a recess formed on the surface of the reservoir substrate opposite from the reservoir space.

8. The liquid drop discharge head according to claim 1, wherein the diaphragm portion is formed of a boron diffused layer obtained by selectively diffusing boron.

9. The liquid drop discharge head according to claim 1, wherein the reservoir substrate is formed of silicon substrate of (100) in plane direction.

10. The liquid drop discharge head according to claim 1, wherein the liquid drop discharge head is formed by joining an electrode substrate having individual electrodes formed in recesses for electrostatically driving oscillating plates constituting the bottom portions of the discharge chambers with the cavity substrate via an insulating film.

11. A method of manufacturing a liquid drop discharge head wherein a diaphragm portion is formed by:
etching a portion corresponding to the diaphragm portion from one of the surfaces of the silicon substrate by a required depth, and
processing a recess which corresponds to a reservoir space from the surface of the silicon substrate on the opposite side by wet etching.

12. A method of manufacturing a liquid drop discharge head wherein a diaphragm is formed by:
etching a portion corresponding to the diaphragm portion from one of the surfaces of the silicon substrate by a required depth,
selectively diffusing boron to a recess formed thereby, and
processing a recess which corresponds to a reservoir space from the surface of the silicon substrate on the opposite side by wet etching.

13. The method of manufacturing a liquid drop discharging head according to claim 11, wherein the wet etching is started with a concentration which provides a high etching rate and changed to a concentration which provides a low etching rate halfway in the process of wet etching of the recess which corresponds to the reservoir space.

14. The method of manufacturing a liquid drop discharging head according to claim 12, wherein the wet etching is started with a concentration which provides a high etching rate and changed to a concentration which provides a low etching rate halfway in the process of wet etching of the recess which corresponds to the reservoir space.
